(19) United States
(12) Patent Application Publication
(10) Pub. No.: US 2006/0106692 A1
(43) Pub. Date: May 18, 2006

(54) Proprietary point of purchase resource

(75) Inventor: Dolor J. Konja, San Diego, CA (US)

Correspondence Address: GORDON & REES LLP, 101 WEST BROADWAY, SUITE 1600, SAN DIEGO, CA, 92101, US

(73) Assignee: Dolor J. Konja

(21) Appl. No.: 10/987,642

(22) Filed: Nov. 12, 2004

(51) Int. Cl. G06Q 40/00

(52) U.S. Cl. 705/35; 705/41

(57) ABSTRACT

The present invention allows consumers to perform various financial transactions from a single source. Consumers fill out an application and are pre-approved for a variety of financial services. The consumer is provided with a smart card, which is embedded with information about the consumer and all the services for which the consumer has been pre-approved. A consumer inserts the smart card into a conveniently located proprietary point of purchase resource and is provided a list of services. The consumer selects a service and the proprietary point of purchase resource performs the service if the consumer has been approved for that service. Services include obtaining a cash-advance, cashing a check, wiring money, obtaining a money order, exchanging foreign currency, paying bills, withdrawing money from an ATM, obtaining a pre-paid phone card and obtaining a pre-paid debit card.

### FIELD OF THE INVENTION

The present invention relates to providing consumers with an all in one point of purchase resource for delivering financial services/transactions.

### BACKGROUND OF THE INVENTION

Every day consumers are faced with the challenge of working full time, raising families and finding the time to run errands, particularly financial services/transactions. To complete all the necessary financial transactions, consumers have to go to several different locations, which takes a considerable amount of time. A lot of consumers spend a good portion of their weekend completing these financial services. These financial services can include obtaining a cash-advance, cashing a check, wiring money, obtaining a money order, exchanging foreign currency, paying bills, withdrawing money from an ATM, obtaining a pre-paid phone card and obtaining a pre-paid debit card.

In addition to having to spend a lot of time going to different locations to perform all the needed financial services/transactions, some consumers do not have bank accounts and credit cards. As a result, it is difficult for these consumers to have access to day to day money transactions/exchanges. What is needed is a single source that allows consumers to perform various financial services and allows consumers without a bank account or credit card to have access to the day to day money transactions/exchanges.

### SUMMARY OF THE INVENTION

It is an object of the present invention to provide a source that allows consumers to perform various financial services/transactions from a single source.

It is another object of the present invention to convert all forms of money transactions that traditionally require paper to a paperless process via smart card technology.

It is yet another object of the present invention to provide a widely available/convenient system that can be placed at any corner market, convenience store and any retailer in residential, industrial and business areas where people work and live.

It is yet another object of the present invention to provide a system that allows consumers who traditionally do not have bank accounts, credit cards, etc. to have access to day to day money transactions/exchanges.

It is yet another object of the present invention to provide a time saving system that allows consumers to quickly perform tasks which typically require human assistance.

It is yet another object of the present invention to provide a user friendly and intuitive system that has a simple step by step instructional process and directs consumers if any errors are made.

It is yet another object of the present invention to provide a system that is a space saver.

It is yet another object of the present invention to provide a system that is language friendly where the consumer can pre-select a language to be greeted in.

In a preferred embodiment of the present invention, a proprietary point of purchase resource that allows consumers to perform various transactions from a single source is provided. Consumers fill out an application and based upon this application, the consumer is pre-approved for a variety of financial services. Upon being approved, the consumer is provided with a smart card, which is embedded with information about the consumer and all the services for which the consumer has been pre-approved.

To utilize the services, the consumer utilizes the smart card with a conveniently located proprietary point of purchase resource. When the card is inserted, the consumer is greeted on a touch screen, as well as with voice commands, and is provided a list of services that can be performed. The consumer selects a service and the proprietary point of purchase resource performs the service if the consumer has been approved for that service. If the consumer has not been approved for that service, the consumer can request expedited approval of the service by using a phone hand set attached to the proprietary point of purchase resource. Services include obtaining a cash-advance, cashing a check, wiring money, obtaining a money order, exchanging foreign currency, paying bills, withdrawing money from an ATM, obtaining a pre-paid phone card and obtaining a pre-paid debit card.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1a is a flow chart illustrating the method utilized in the preferred embodiment allowing consumers to perform multiple fianancial/services from a single source;

FIG. 1b illustrates an example of a screen shot that greets the consumer and asks the consumer to insert a smart card;

FIG. 1c illustrates an example of a screen shot that appears after the consumer has successfully logged into the system;

FIG. 1d illustrates an example of a screen shot if the consumer is not pre-approved for a service that was selected;

FIG. 1e illustrates an example of a screen shot instructing the consumer to collect money from a cash dispenser; and

FIG. 2 illustrates a device of the preferred embodiment of the present invention that allows consumers to perform multiple financial services.

### DETAILED DESCRIPTION OF THE DRAWINGS

In a preferred embodiment of the present invention, a proprietary point of purchase resource that allows consumers to perform various transactions from a single source is provided. To utilize this resource, a consumer uses a smart card that is embedded with information and pre-approved services that allow the consumer to perform various transactions, particularly financial. The information embedded on the smart card includes, but is not limited to, the address of the consumer, account information (such as a savings or checking account), a list of companies or services that the consumer has bills with, available minutes for telephone calls, and pre-paid money available for use as a debit card. The smart card also contains a picture of the consumer and can be used to compare to a database of pictures of consumers utilizing this system. The smart card is utilized on the resource, such as a system or machine, which allows the consumer to perform all the transactions at one time and at one location.

Smart cards include one or more smart chips or integrated circuits (“IC”) located within the body of the card to receive and store information. The ICs can be read-only or have read/write capability. The smart cards also contain interface means, which will depend on whether the smart card is a contact-type or contactless smart card. Contactless cards will contain an antenna structure for communication with an RF source, and typically include circuitry adapted for deriving operating power from the RF signal.

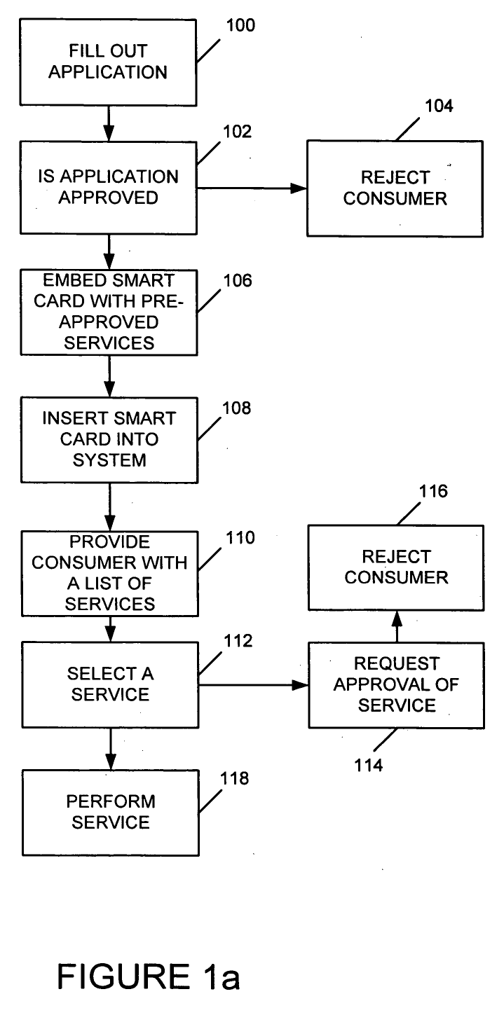

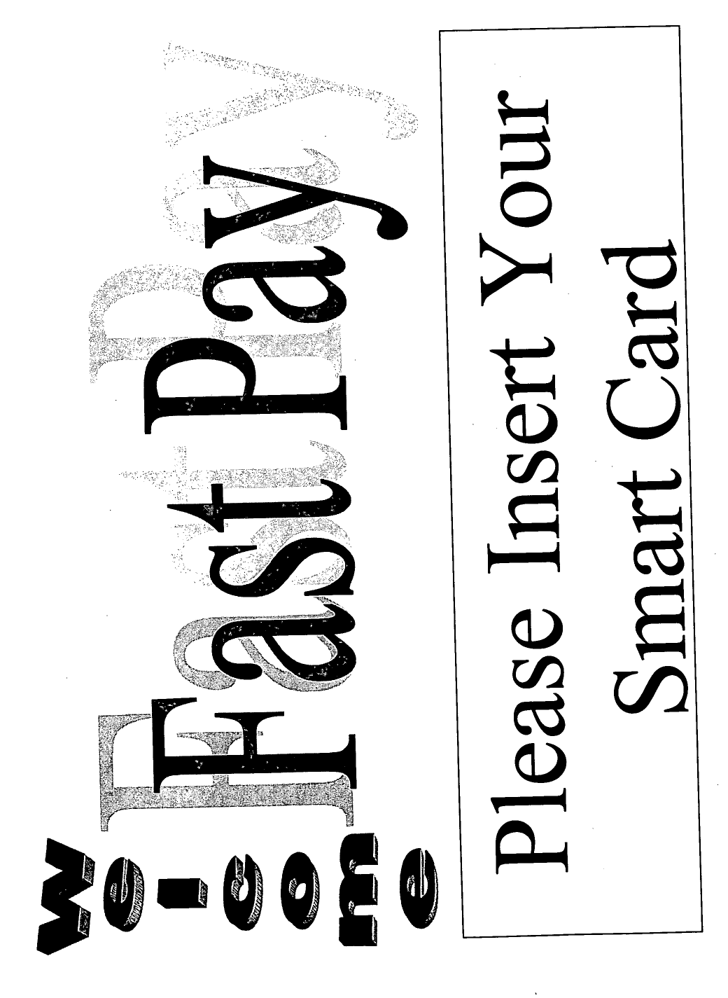

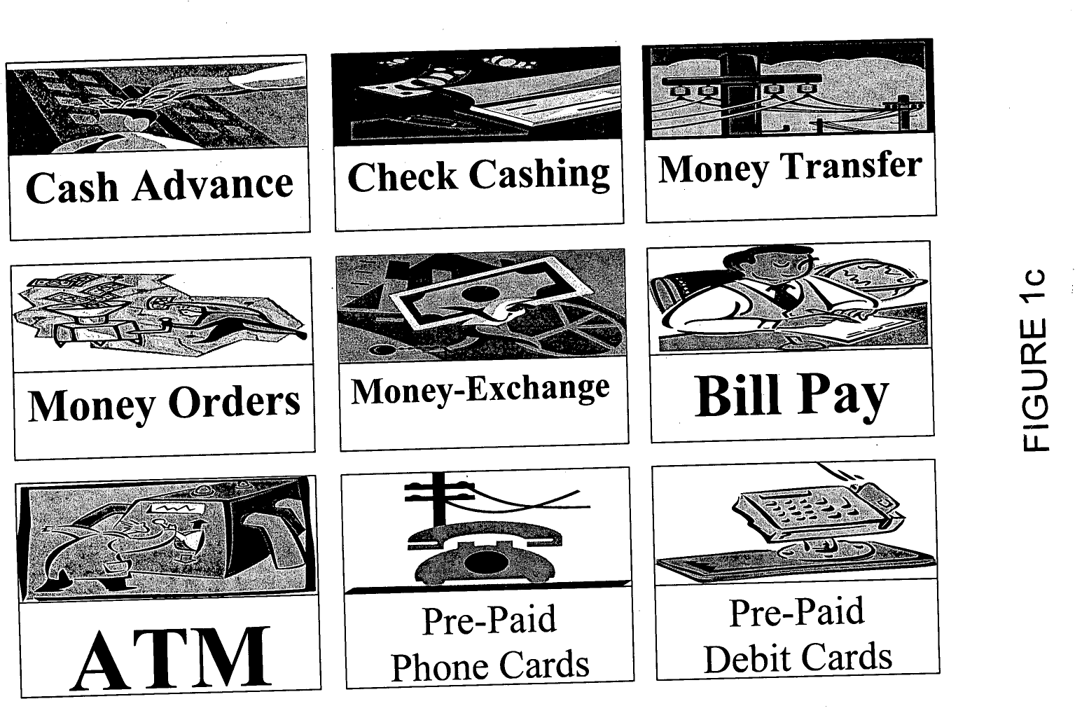

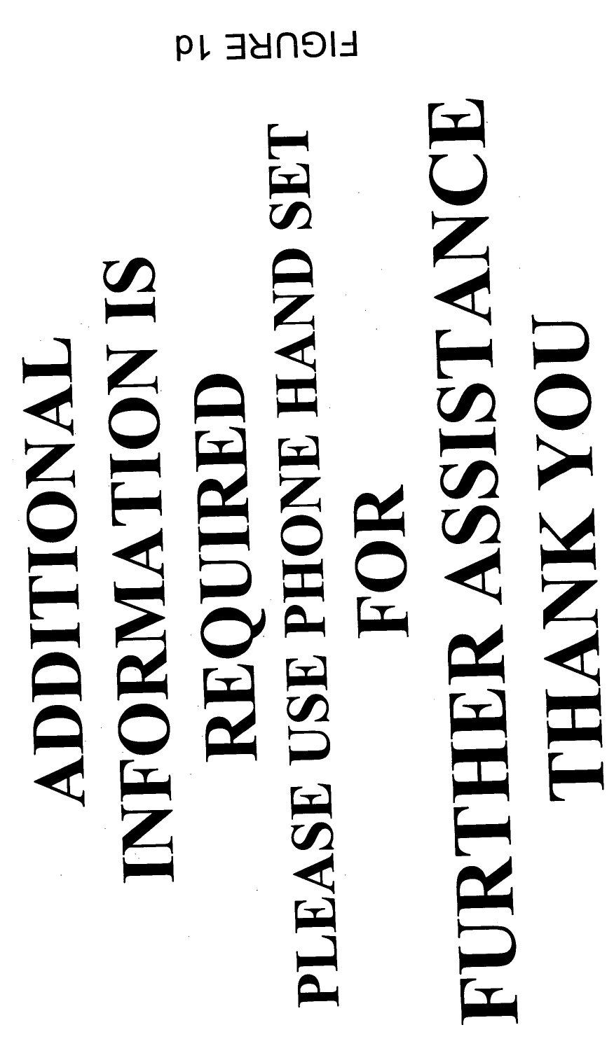

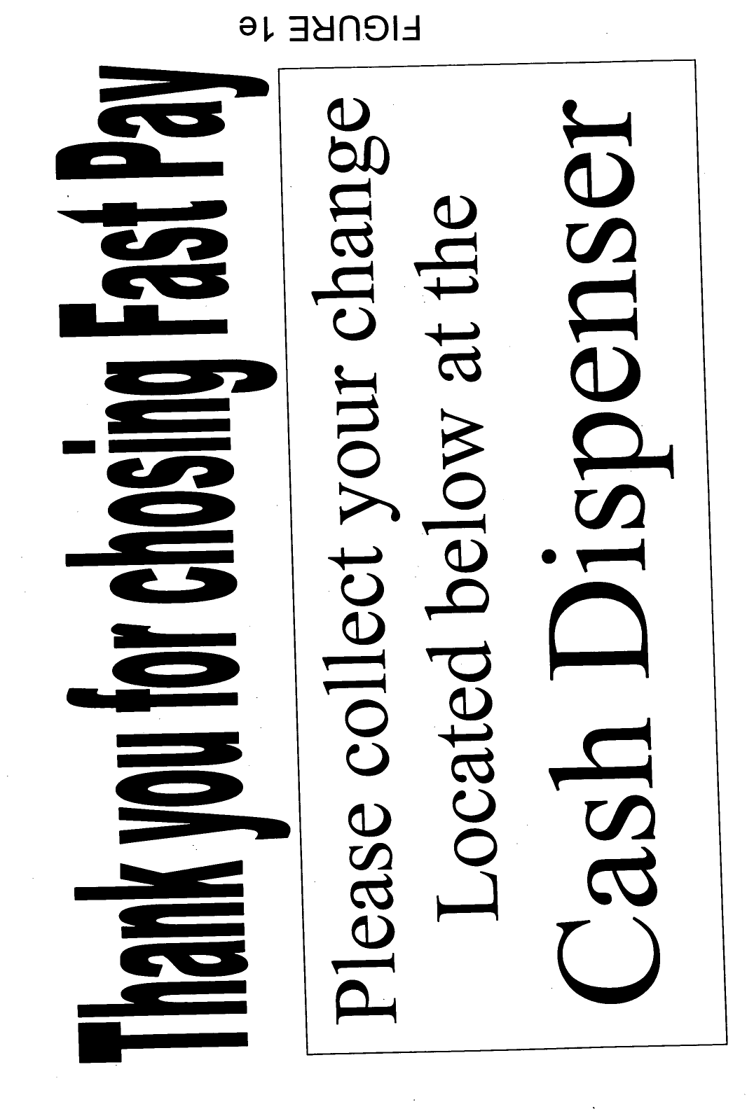

FIG. 1a illustrates a flow diagram of the method of utilizing the proprietary point of purchase resource of the present system. First, a consumer fills out an application 100 providing information such as the consumer's name, address, telephone numbers, place of employment, salary, bank account information, list of bills to pay on the system, and preferred language to be greeted in. Once the application has been completed, a determination is made, based on the information contained in the application, if the consumer is approved to utilize the system 102. Each consumer that is approved may not be approved for all available services. Available services include, but are not limited to, obtaining a cash-advance, cashing a check, wiring money, obtaining a money order, exchanging foreign currency, paying bills, withdrawing money from an ATM, obtaining a pre-paid phone card and obtaining a pre-paid debit card. If the consumer does not quality for any services, the consumer is rejected.

Once a consumer is approved, a smart card is embedded with the consumer's information and the services for which the consumer has been pre-approved 106. Additionally the smart card contains a picture of the consumer. The consumer is then provided with the smart card, which will allow the consumer to access any available system. To access the system, the consumer inserts the card into the system 108 and the system requests the consumer to enter a pin or access number for security purposes. Upon verification of the pin or access number, the system greets the consumer in the language the consumer indicated on the application. FIG. 1b illustrates an example of a screen shot that requests the consumer to insert a smart card. English is the default language unless another language is requested on the application. The consumer is not only greeted by a screen shot on a display screen, but is also greeted with voice commands. After the greeting, the system will display a list of services that the system is capable of performing for the consumer to select from 110. FIG. 1c illustrates an example of a screen shot that appears after the consumer has successfully logged into the system.

From the list, a consumer is prompted to choose a service to be performed. Once the consumer selects a service 112, the system determines if the consumer is pre-approved for that service based upon the information stored on the smart card. If the consumer requests a service that has not been pre-approved, the consumer is told that additional information is needed and to utilize a phone hand set on the system for further assistance. FIG. 1d illustrates an example of a screen shot if the consumer is not pre-approved for a service that was selected. This expedited request 116 is then made using the phone hand set that is provided with the system. Having a phone hand set to request approval of additional services reduces the need of a clerk and maintains crucial transactions at the back end to maintain security. (Back end processes must have all levels of security pre-installed.) The approval either can be automated or through a person at the other end of the line. If the consumer is rejected 118, the consumer is given the option of choosing another service or ending the transaction and receiving the smart card back. If the consumer selects a pre-approved service, the service is performed 120.

If the consumer selects the cash advance service, a series of verifications using the system primarily on the back end and within seconds a check in United States dollars is provided. This check can be cashed at any location that cashes checks. Alternatively, the consumer can request that the cash advance be credited to the smart card account, which can be debited as an ATM/debit transaction. Depending upon the relationship of the retailer with the system, a fee is displayed for the consumer to either accept or reject the transaction.

If the consumer selects the check cashing service, the system first verifies the card and requests that the check be inserted and then a bio metric read will be required to cross check the consumer's information in the system. In addition to the biometric read, a camera cross checks the consumer's facial image with the consumer's facial image stored in a database. The system then verifies the validity of the check to make sure it isn't counterfeit, there has been a stop payment, the date for cashing hasn't passed, etc. Once the validity has been verified, the system verifies the amount on the check. Depending upon the relationship of the retailer with the system, a fee is displayed for the consumer to either accept or reject the transaction. The system will stamp the check acknowledging it has been cashed and the check is held with the retailer on file for a period of years. The retailer receives the credit, or fee, electronically.

The system, or a clerk if available, will dispense the money to the consumer. Alternatively, the money can be credited to the consumer's smart card and be debited as an ATM/debit transaction. The consumer can also choose to receive some of the money in cash and the rest of the money credited to the consumer's smart card. Depending upon the relationship of the retailer with the system, a fee is displayed for the consumer to either accept or reject the transaction.

If the consumer selects the wire/money transfer service, the system first verifies the card to determine the amount of money the consumer has available on the card. By utilizing a pre-approved service, the consumer does not have to fill out any forms at a counter, as is required by other businesses that provide the service of wire/money transfer. The consumer transaction history will be handled on the back end, utilizing the smart card. Once a transaction is at the final stage, a clerk or the system will request the money to be transferred, thus completing the transaction. The amount of money available to the consumer is reduced by the amount of money that is transferred. Depending upon the relationship of the retailer with the system, a fee is displayed for the consumer to either accept or reject the transaction.

If the consumer selects the money order service, the system first verifies the card to determine the amount of money the consumer has available on the card. The system has the ability to dispense money orders or a clerk can perform this service. Money orders can be obtained from the money the consumer has stored on the card or money that the consumer inserts into the system. If a clerk provides the money order, the clerk will accept the money and dispense the money order. The clerk can accept cash or utilize money available on the card. If the money is taken from the money on the card, the amount of money on the card is reduced by the amount of the money order. Depending upon the relationship of the retailer with the system, a fee is displayed for the consumer to either accept or reject the transaction.

If the consumer selects the money exchange service, the system first verifies the card. Once the card has been verified and the consumer tells the system which foreign currency is to be exchanged, the system displays the current rate of exchange and the system's fees to perform the transaction. Alternatively, a clerk has the ability to inform the consumer of the current exchange rate and fee to complete the transaction. The fees can be applied against the consumer's available money on the card or the consumer can insert money into the system. Exact change is not required and the system can provide change.

If the consumer selects the bill pay service, the system first verifies information of the bills the consumer has set up to pay. This information includes the names and addresses of all the companies or services to be paid. The consumer instructs the system which company to pay and how much to pay that company. The system, or a clerk, can accept cash, or utilize the consumer's money available on the card. If the money is taken from the money on the card, the amount of money on the card is reduced by the amount of the bill or bills that are paid. A transaction fee for each bill to be paid is charged.

If the consumer selects the ATM service, the process is identical to the current ATM machine set up that is currently being utilized by other companies. This service is being provided as a form of revenue. The system will offer the consumer the ability to place money in the consumer's account and shall have the ability to use the card issued as an ATM/debit card at any of the system's locations.

If the consumer selects the pre-paid phone card service, the consumer will use a card reader that is part of the system to replenish the card with minutes. The user inserts the card into the card reader and the consumer is prompted to select the number of minutes to add to the card and is provided with the cost of adding the pre-selected amount of minutes along with the transaction fee. The system, or a clerk, can accept cash, or utilize the consumer's money available on the card. If the money is taken from the consumer's money on the card the consumer's amount of money on the card is reduced by the cost of the minutes added to the card as well as the transaction fee.

If the consumer selects the pre-paid debit card, the consumer will use a card reader that is part of the system to replenish the card with funds. The consumer inserts the card into the card reader and the consumer is prompted to select the amount of money to be added to the pre-paid debit card. The system, or a clerk, can accept cash.

The system in the preferred embodiment of the present invention has the ability to perform the same services that a clerk can do. In addition to providing the consumer with a single source of performing multiple financial transactions, the system provides the consumer with many additional advantages. First, all forms of money transactions that traditionally require paper will be converted into a paperless process via the smart card technology. Second, the system has the ability to be widely available and convenient. The system can be placed at any corner market, convenience store and any retailer in residential, industrial and business areas where people work and live. Third, the system provides consumers who do not have bank accounts, credit cards, etc. the access to day to day money transactions/exchanges that they normally would not have access to. Four, the system saves time in that it allows consumers to quickly perform multiple tasks in one location that typically require human assistance. Fifth, the system is user friendly and intuitive. It has a simple step by step instructional process and directs the consumer if any errors are made both on the display screen and with voice commands. Sixth, the system is a space saver. The system will take the place of ATM machines and the like, which take up a large amount of room from the business, which can otherwise be used for an additional profit center. Finally, the system is language friendly. The consumer can choose the language the consumer prefers to be greeted in.

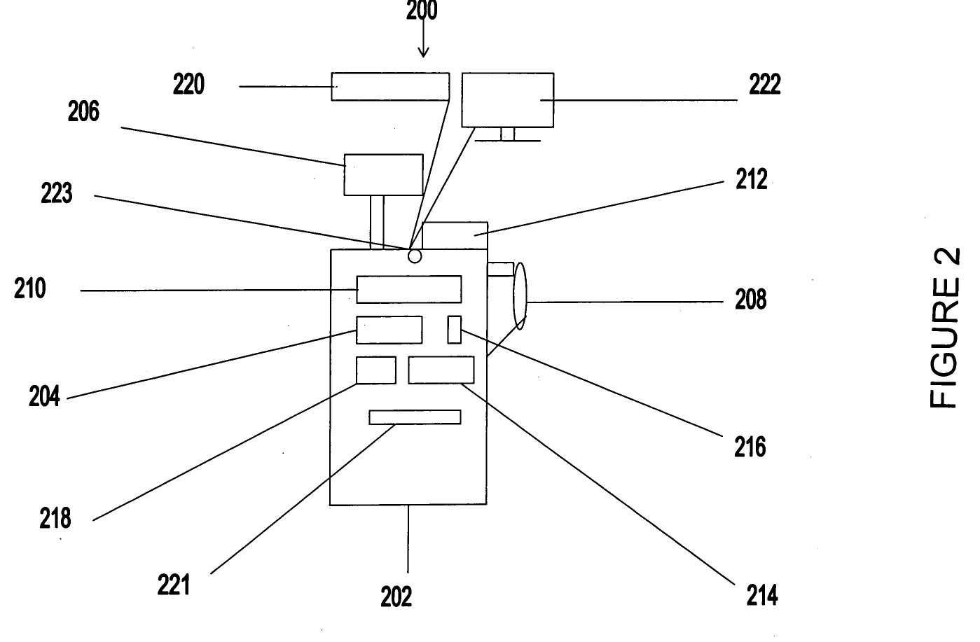

Turning to FIG. 2, a preferred embodiment of a device 200 utilized in the system is illustrated. The device is made of secure cabinetry 202 providing security for the cash, checks and other information stored inside. To utilize the system, a consumer either inserts a smart card into the card reader 204 or passes the smart card by the card reader 204, depending on whether the smart card is contact or contactless. Once the card reader 204 reads the card, the consumer is greeted with a message on the touch screen 206 in the consumer's preferred language. The consumer is then provided a list of services to select from on the touch screen 206. From the list, the consumer selects the service to be performed. If the consumer is not pre-approved for the service that has been selected, the consumer can utilize a phone hand set 208 to seek approval for the service. The device also comprises a check acceptor 210 for inserting a check to be cashed, a cash acceptor 212 for accepting cash needed to perform a service, a money order dispenser 214 for dispensing money orders that have been purchased, a magnetic strip reader 216 for reading an ATM card, a camera 223 for cross checking the consumer's facial image with the consumer's facial image stored in a database, a printer 218 for printing the consumer a receipt and a cash dispenser 221 for dispensing cash. The system also contains a keyboard 220 and a second touch screen monitor 222 that are used by clerks in systems that have the ability to utilize a clerk.

Although an exemplary embodiment of the invention has been described above by way of example only, it will be understood by those skilled in the field that modifications may be made to the disclosed embodiment without departing from the scope of the invention, which is defined by the appended claims.

I claim:

1. A method of providing a proprietary point of purchase resource, allowing consumers to perform multiple financial services from a single source, the method comprising the steps of:
filling out an application with information about a consumer;
determining if the consumer is approved for available services;
establishing an account for the consumer if the consumer has been approved for at least one of the available services;
embedding a smart card with the consumer's information, including the at least one of the available services that the consumer has been approved for;
inserting the smart card into the proprietary point of purchase resource;
providing the consumer with a list of the available services to select from;
selecting a service from the list of available services and determining if the consumer is pre-approved for the selected service as indicated by the smart card; and
performing the selected service if the consumer is pre-approved for that service.

2. The method of claim 1, wherein the proprietary point of purchase resource recognizes the consumer upon insertion of the smart card into a card reader in the resource and greets the consumer in the consumer's native language.

3. The method of claim 1, wherein the consumer's information includes the consumer's bank account number.

4. The method of claim 1, wherein the consumer's information includes a list of businesses that requires payment by the consumer.

5. The method of claim 1, wherein if the consumer selects a service from the proprietary point of purchase resource that the consumer is not pre-approved for, the consumer can expedite a request for approval utilizing a landline phone and if approved, the service is automatically added to the consumer's smart card.

6. The method of claim 1, wherein the available services are selected from a group consisting of cash advance, check cashing, wire/money transfer, money order, money exchange, bill pay service, ATM, pre-paid phone card and pre-paid debit card.

7. The method of claim 3, wherein the consumer pays for the selected service with the money stored on the card and the cost of the selected service is deducted from the amount of money stored on the card.

8. The method of claim 1, wherein the consumer pays a transaction fee for each selected service.

9. The method of claim 1, further comprising the steps of:
inserting a check to be cashed into the proprietary point of purchase resource; and
instructing the proprietary point of purchase resource where to locate the money from the check.

10. The method of claim 9, wherein the money is dispensed from the proprietary point of purchase resource.

11. The method of claim 9, wherein the money is added to the consumer's account on the smart card.

12. The method of claim 1, wherein the selected service is cash advance and amount of cash advance to the consumer is based upon the consumer's line of credit established on the smart card.

13. The method of claim 1, wherein the consumer can insert cash into the proprietary point of purchase resource to increase the amount of money on the consumer's account or add minutes to a pre-paid phone card.

14. The method of claim 1, wherein the proprietary point of purchase resource comprises:
a secure cabinet housing;
a card reader for reading information from the smart card, located in the secured cabinet housing;
a touch screen for selecting the service, located on the secure cabinet housing;
a phone hand set, for requesting an additional service that is not pre-approved, attached to the secure cabinet housing; and
a check acceptor for accepting check to be cashed and a money order dispenser for dispensing money orders embedded in the secure cabinet housing.

15. The method of 1, wherein the consumer is provided step by step instructions on how to utilize the services with voice commands.
